(19) United States
(12) Patent Application Publication
(10) Pub. No.: US 2012/0267298 A1
(43) Pub. Date: Oct. 25, 2012

(54) WATER PURIFICATION SYSTEM

(75) Inventor: Kim Weis Hansen, San Diego, UT (US)

(73) Assignee: CONNEXION4, San Diego, CA (US)

(21) Appl. No.: 13/091,814

(22) Filed: Apr. 21, 2011

(51) Int. Cl. C02F 1/00

(52) U.S. Cl. 210/198.1

(57) ABSTRACT

One example embodiment includes a system for purifying water. The system includes a water input system, where the water input system is configured to receive water. The system also includes a sanitization circuit, where the sanitization circuit is configured to add a sanitization compound to the water to produced purified water. The system further includes an output circuit, wherein the output circuit is configured to output the purified water.

### CROSS-REFERENCE TO RELATED APPLICATIONS

Not applicable.

### BACKGROUND OF THE INVENTION

Fresh water is an important natural resource. Not only is it used for drinking, it is used in numerous other ways as well, such as agriculture, industry food preparation, cleaning and numerous other ways. However, a large portion of available fresh water is unsuitable for certain uses without prior treatment. For example, drinking untreated water can lead to disease or even death. Microbes in the water can wreak havoc on the drinker's digestive system if not treated properly. Unfortunately, a large portion of the world's population does not have access to clean drinking water. Some estimates indicate that the number may be as many as one billion people worldwide. Although many of these people have access to water, it is often polluted by industrial waste, sewage or other contaminants that make it unsuitable for drinking.

In addition, many of our other uses of water result in waste water that is unsuitable for drinking or other uses. This is a natural byproduct of some of the ways that we use water. In some cases the waste water can be used. For example, some waste water can be used for agricultural processes in which the contaminants will either not be absorbed or in which the contaminants will be naturally broken down. For example, water contaminated with fecal matter may be used for agricultural purposes as the fecal matter is broken down and used as fertilizer by plants. However, this water is unsuitable for many uses and much of this water is put back into natural areas, such as rivers, lakes and oceans.

There are treatment systems available which allow for water to be made suitable for drinking or for other uses as needed. However, these systems tend to either be very large or very small. I.e., they are used on a very large scale, such as municipal water supplies, or on a very small scale, such as hand held filters that are used by backpackers. Therefore, these systems are not practical for other users. For example, in remote locations or in medium size applications such as single dwellings.

In addition, these systems tend to produce water that is the same, regardless of the intended use. For example, many users dislike the taste of the water produced by these systems. Additionally, water that is intended for industrial uses may need to have minerals or other contaminants removed while other contaminants can be ignored.

Accordingly, there is a need in the art for a water purification system that can produce adequate drinking water regardless of the water source. In addition, there is a need in the art for the water purification system to be able to restore waste water to a drinkable state. Further, there is a need in the art for the system to be scalable. Additionally, there is a need in the art for the system to be configurable, to remove more or less contaminants or to remove specific contaminants.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for purifying water. The system includes a water input system, where the water input system is configured to receive water. The system also includes a sanitization circuit, where the sanitization circuit is configured to add a sanitization compound to the water to produced purified water. The system further includes an output circuit, wherein the output circuit is configured to output the purified water.

Another example embodiment includes a system for purifying water. The system includes a water input system, where the water input system is configured to receive water. The system also includes a water storage system, where the water storage system is configured to store the water. The system further includes a sanitization circuit, where the sanitization circuit is configured to add a sanitization compound to the water to produced purified water. The system additionally includes an output circuit, wherein the output circuit is configured to output the purified water.

Another example embodiment includes a system for purifying water. The system includes a water input system, where the water input system is configured to receive water. The water input system includes a filter, where the filter is configured to remove particulates from the water, and a pump, where the pump is configured to increase the pressure of the water. The water input system also includes a pressure control, where the pressure control is configured to control the pump, and a flow meter, where the flow meter measures the amount of water input to the system. The system also includes a water storage system, where the water storage system is configured to store the water. The water storage system includes a storage tank and a level sensor, where the level sensor detects the water level within the storage tank. The water storage system also includes a valve, where the valve is configured to prevent water from entering the storage tank if the water level in the storage tank is above a threshold level. The system further includes a sanitization circuit, where the sanitization circuit is configured to add a sanitization compound to the water to produced purified water. The sanitization circuit includes a pump, where the pump is configured to move the water through the sanitization circuit and a reactor, where the reactor is configured to produce the sanitization compound. The sanitization circuit also includes a sanitization compound sensor, where the sanitization compound sensor is configured to measure the amount of sanitization compound added to the water. The system additionally includes an output circuit, wherein the output circuit is configured to output the purified water. The output circuit includes a pump, where the pump is configured to pump the purified water from the water storage system, and a filter, where the filter is configured to remove from the purified water one of dissolved heavy metals, odors or tastes. The output circuit also includes an outflow, where the outflow allows access to the purified water. The system also includes a control circuit, wherein the control circuit is configured to control the operation of the water purification system.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a block diagram of an example system for purifying water;

FIG. 2 illustrates a block diagram of an example of a water input system;

FIG. 3 illustrates a block diagram of an example of a water storage system;

FIG. 4 illustrates a block diagram of an example of a sanitization circuit;

FIG. 5 illustrates a block diagram of an example of an output circuit; and

FIG. 6 illustrates a block diagram of an example of a system for purifying water.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

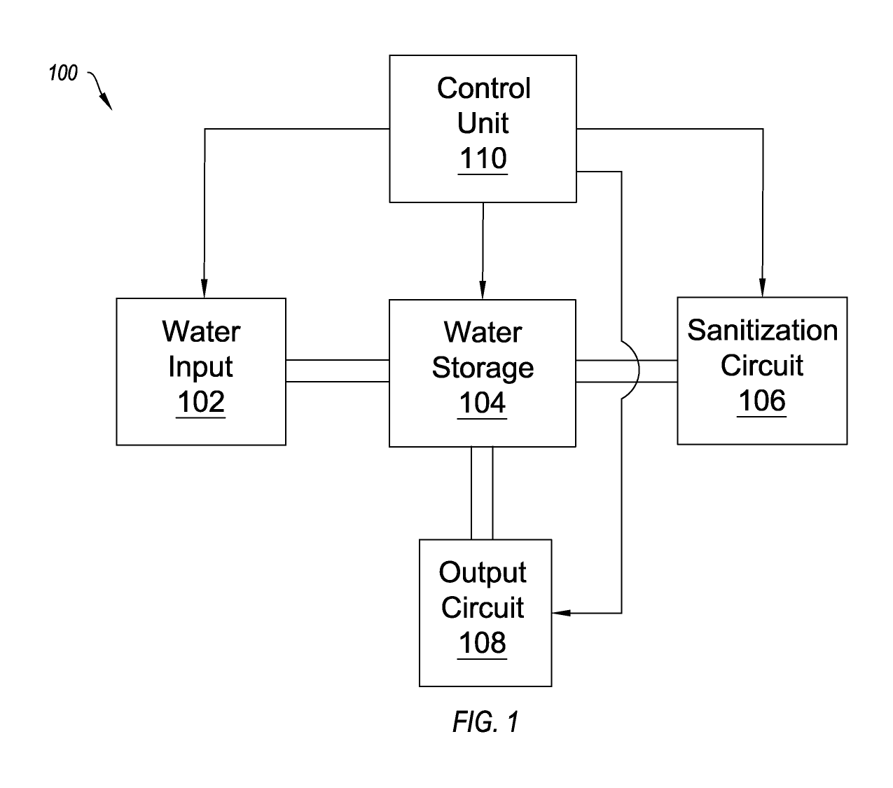

FIG. 1 illustrates a block diagram of an example system 100 for purifying water. In at least one implementation, water purification can include removing toxins, silt, organic materials, bacteria, viruses, microbes, sewage or any other undesirable material. The composition of the water, including any substances not removed or remaining, can be configured to any desired level. After treatment, the water can be used for any desired purpose, including sanitization, drinking, cooking or any other purpose.

In at least one implementation, they system 100 can be scalable. I.e., the system 100 can be used for large scale water purification of for localized water purification. For example, the system 100 can be used to produce municipal or building water sources or to produce purified water for individual dwellings.

FIG. 1 shows that the system 100 can include a water input 102. In at least one implementation, the water input 102 can include any water source that the user would like to purify. The water input 102 can include some basic water treatment capabilities, as described below. For example, the water input 102 can include piping from a water source, such as a municipal water supply or a storage tank which stores clean water or which is capable of filtering water. Additionally or alternatively, the water input 102 can include previously untreated water.

In at least one implementation, the water input 102 can include waste water (also “wastewater”). I.e., the system 100 can be used to recycle waste water for further use. Waste water is any water that has been adversely affected in quality by anthropogenic or other influence. The previous water user can include any user which produces waste water. In particular, the previous water user can include large facilities which use large amounts of water. For example, the previous water user can include food producers, restaurants, wine producers, industrial facilities and the like. One of skill in the art will appreciate that the nature of the previous water user is not limiting herein unless otherwise specified in the claims.

FIG. 1 also shows that the system 100 can include a water storage system 104. In at least one implementation, the water storage system 104 can store water to be purified or which has been previously partially purified, as described below. Additionally or alternatively, the water storage system 104 can allow water to be stored until needed. For example, if the water source used by the water input 102 is sporadic or low pressure/low flow, the water storage system 104 can allow for the end user to have water available when needed.

FIG. 1 further shows that the system 100 can include a sanitization circuit 106. In at least one implementation, the sanitization circuit 106 can include a system which is capable of filtering or sanitizing the waste water produced by the previous water user or naturally occurring in the water source. In particular, the sanitization circuit 106 is capable of removing the waste elements in the water and preventing microbial growth within the water. Additionally or alternatively, the sanitization circuit 106 can concentrate the waste elements into a portion of the waste water, leaving the remaining portion suitable for the desired use.

In at least one implementation, the purified water produced by the sanitization circuit 106 can be returned to the water storage system 104. For example, the water storage system 104 can include storage into which the purified water can be added. Additionally or alternatively, sanitization circuit can return water with one or more sanitizing compounds to the water storage system 104 in high enough concentrations to sanitize all of the water stored in the water storage system 104, as described below.

FIG. 1 additionally shows that the system 100 can include an output circuit 108. In at least one implementation, the output circuit 108 can allow access to the purified water. I.e., the output circuit 108 can make the purified water available for use. The access can be direct (i.e., the user accesses the water near the system 100) or indirect (i.e., the water is pumped or moved to a separate location for use), as described below.

FIG. 1 also shows that the system 100 can include a control unit 110. In at least one implementation, the control unit 110 can control the operation of the other elements of the system 100. For example, the control unit 110 can control the rate at which the sanitation circuit 106 is producing the desired sanitizing compound and/or the rate at which it is being added to the water storage system 104, the rate at which the water input 102 is allowing water to enter the system, the rate at which the system is allowing the output circuit 108 to remove water from the system 100, or any other control parameters of the system 100. One of skill in the art will appreciate that the control unit 110 can include a single unit controlling all parameters or multiple unites controlling single parameters or a subset of parameters.

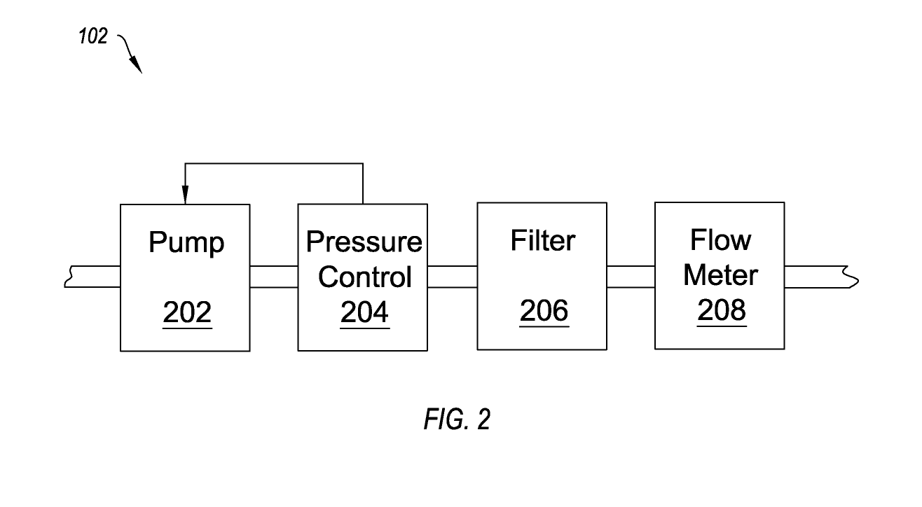

FIG. 2 illustrates a block diagram of an example of a water input system 102. In at least one implementation, the water input system 102 can allow for the input of water into a water purification system, such as the system 100 of FIG. 1. In particular, the water input system 102 can prepare the water for sanitization and purification, as described above.

FIG. 2 shows that the water input system 102 can include a pump 202. In at least one implementation, the pump 202 can be used to transport water into the water input system 102. I.e., the pump 202 can increase the pressure of the water flowing into the water input system 102. This can allow the water input system 102 to be used with non-pressure or low pressure water systems, such as natural bodies of water or stagnant water. One of skill in the art will appreciate that the pump 202 can include a mechanism from preventing silt from interfering with the working of the pump 202.

FIG. 2 also shows that the water input system 102 can include a pressure control 204. In at least one implementation, the pressure control 204 can ensure that the pressure of the water is the desired value or within the desired range. For example, the pressure control 204 can control the operation of the pump 202. One of skill in the art will appreciate that the pressure control 204 can control the operation of the pump 202 directly or can control the pressure via a control unit, such as the control unit 110 of FIG. 1. Additionally or alternatively, the pressure control 204 can include a regulator which releases extra pressure to protect the water input system 102.

FIG. 2 further shows that the water input system 102 can include a filter 206. In at least one implementation, the filter can provide the first stage of purification. I.e., the filter 206 can remove large impurities from the water. For example, the filter 206 can remove silt, food particles or other large impurities. The filter 206 can remove this to prevent them damaging or clogging other parts of the water purification system.

FIG. 2 additionally shows that the system 200 can include a flow meter 208. In at least one implementation, the flow meter 208 can measure the amount of water entering the water input system 102. In particular, the amount of water entering the system can determine the amount of chemical treatment required for the water input system 102. The flow meter can send a signal to a control unit which monitors the flow and adjusts the operation of the pump 202 and/or pressure control 304 as needed.

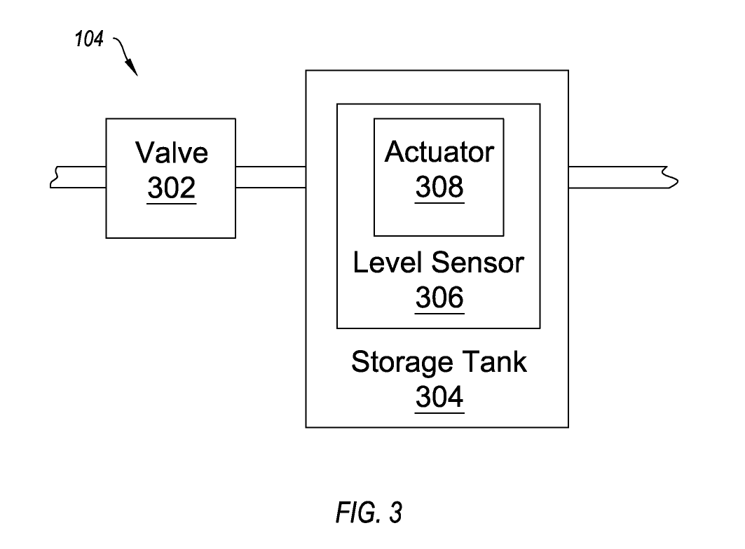

FIG. 3 illustrates a block diagram of an example of a water storage system 104. In at least one implementation, the water storage system 104 can store water that requires sanitization. For example, the water storage system 104 can store water that has been introduced into a water purification system, such as water purification system 100 of FIG. 1, via a water input system, such as the water input system 102 of FIGS. 1 and 2.

FIG. 3 shows that the water storage system 104 can include a valve 302. In at least one implementation, the valve 302 can control the amount of water entering the water storage system 104. In particular, the valve 302 can close when there is sufficient water within the water storage system 104 and can open when more water is needed. For example, the valve 302 can include a solenoid valve or other electronically controlled valve. A solenoid valve is an electromechanical valve where the operation of the valve is controlled by an electric current through a solenoid.

FIG. 3 also shows that the water storage system 104 can include a storage tank 304. In at least one implementation, the storage tank 304 can buffer the water capacity of the water storage system 104. In particular, the storage tank 304 can store water which has been purified so that the response to a demand for water can be immediate or nearly immediate. I.e., the storage tank 304 can allow for a continuous supply of purified water. Additionally or alternatively, the storage tank 304 can allow the incoming water to be purified before it exits the water storage system 104, as described below.

FIG. 3 further shows that the water storage system 104 can include a level sensor 306. In at least one implementation, the level sensor 306 can detect the amount of water in the storage tank 304. In particular, the level sensor 306 can detect when the water level goes below a certain threshold level, which indicates that the valve 302 should be opened, allowing more water to enter the storage tank 304. Additionally, the level sensor 306 can detect when the water level goes above a certain threshold level, which indicates that the valve 302 should be closed, preventing more water from entering the storage tank 304.

FIG. 3 additionally shows that the water storage system 104 can include an actuator 308. In at least one implementation, the actuator 308 can include any device that can convert the physical position of the level sensor 306 to an electrical signal. I.e., the level sensor 306 moves based on the water level within the storage tank 304. The movement is then converted to an electrical signal, which can control the valve 302 either directly or indirectly. For example, the actuator 308 can send a signal to a control unit, such as the control unit 110 of FIG. 1, which can then control the valve 302.

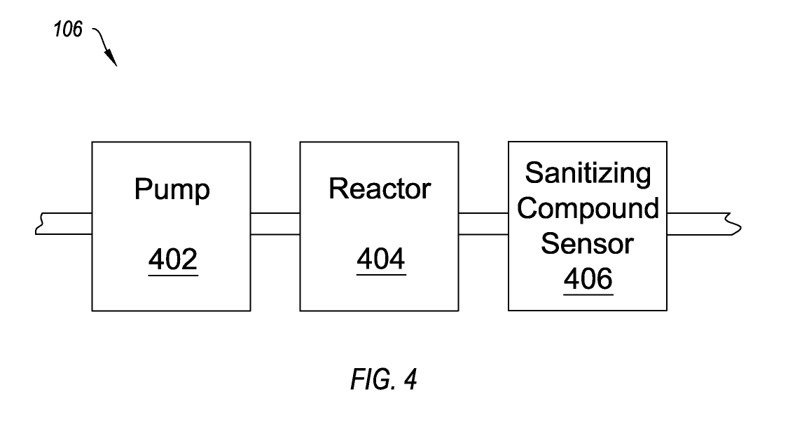

FIG. 4 illustrates a block diagram of an example of a sanitization circuit 106. In at least one implementation, the sanitization circuit 106 can produce a sanitizing compound to be added to the water. The sanitizing compound can include any chemical or combination of chemicals which can be used to purify the water. Additionally or alternatively, the sanitization circuit 106 can add the desired sanitization compound which has been produced elsewhere. One of skill in the art will appreciate that the sanitization circuit 106 can produce or add any sanitizing compound which is meant to remove the desired impurities from the water or otherwise modify or kill the impurities present in the water.

FIG. 4 shows that the sanitization circuit 106 can include a pump 402. In at least one implementation, the pump 402 can move water through the sanitization circuit 106. In particular, the pump 402 can move water from a storage tank, such as the storage tank 304 of FIG. 3, through the sanitization circuit 106 and back into the storage tank. This can ensure that enough of the sanitizing compound is added to the storage tank to properly sanitize the water.

FIG. 4 also shows that the sanitization circuit 106 can include a reactor 404. In at least one implementation, the reactor 404 produces the desired sanitizing compound. For example, the reactor 404 can electrolytically generate hypochlorite which can be used as an oxidizing agent to remove impurities such as nitrates, nitrites, sulfates and organic compounds for sanitizing the water. E.g., the reactor 404 can electrolytically control the reaction Cl₂+2NaOH→NaCl+NaClO+H₂O to produce the desired amount of hypochlorite.

In at least one implementation, the amount of sanitizing compound added to the water can be based on the amount of water entering a water purification system, such as the water purification system 100 of FIG. 1. For example, the amount of water can be measured by a flow meter, such as the flow meter 208 of FIG. 2, and the proper amount of sanitization compound can be calculated by a control unit, such as the control unit 110 of FIG. 1, and then added by the reactor 404. Additionally or alternatively, the amount of sanitizing compound added can be configured to keep the concentration of the sanitizing compound in the storage tank at a certain level or within a desired range. For example, in the process of electrolysis, a control unit, such as the control unit 110 of FIG. 1, can increase or decrease the amount of electricity supplied to the sanitization circuit 106 and thus the rate at which the sanitizing compound is produced.

FIG. 4 further shows that the sanitization circuit 106 can include a sanitizing compound sensor 406. In at least one implementation, the sanitizing compound sensor 406 can determine the amount of sanitizing compound actually added to the water. For example, the sanitizing compound sensor 406 can determine the amount of sanitizing compound added to the water and report the amount to a control unit, such as the control unit 110 of FIG. 1. The control unit can then control the operation of the reactor 404 to ensure that the proper amount of sanitization compound is being produced.

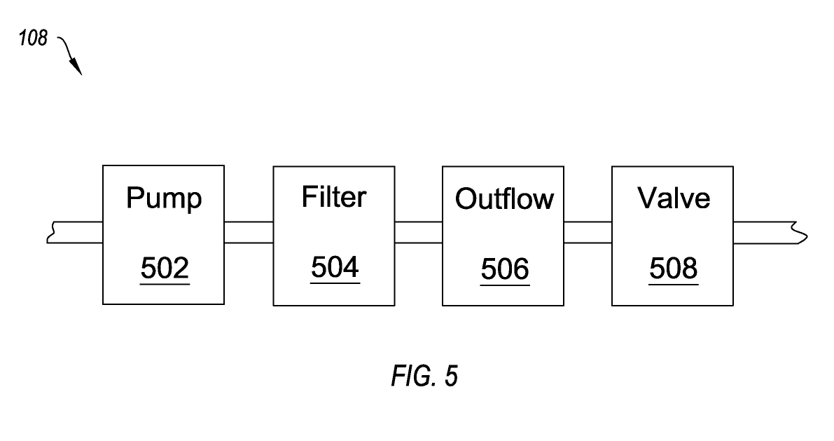

FIG. 5 illustrates a block diagram of an example of an output circuit 108. In at least one implementation, the output circuit 108 can allow the purified water to be accessed by a user. For example, the output circuit 108 can make purified water directly accessible to a user. Additionally or alternatively, the output circuit 108 can transport the water to where it will be accessed by the user.

FIG. 5 shows that the output circuit 108 can include a pump 502. In at least one implementation, the pump 502 can be configured pump water from a storage tank, such as the storage tank 304 of FIG. 3. For example, the pump 502 can pump water through a ring pipe. Additionally or alternatively, the pump 502 can provide a sufficiently high pressure that passive water extraction can occur at a remote location, as described below.

FIG. 5 further shows that the output circuit 108 can include one or more filter cartridges 504. In at least one implementation, the filter cartridges 504 can remove any dissolved heavy metals, odors and tastes in the water. I.e., the filter cartridges 504 can provide any final filtering needed before the water is used for its intended purpose. One of skill in the art will appreciate that the type of filter cartridge 504 can be modified to ensure that the water is within any desired final parameters.

FIG. 5 additionally shows that the output circuit 108 can include one or more outflows 506. In at least one implementation, the outflows 506 allow water to exit the output circuit 108. In particular, the outflows 506 can include hose bibs, pipes faucets or any other device or apparatus for allowing the water to exit the output circuit 108. For example, the outflows 506 can include faucets, which users can access when purified water is needed.

FIG. 5 also shows that the output circuit 108 can include a valve 508. In at least one implementation, the valve 508 can provide back pressure within the ring pipe. Back pressure refers to the resistance to the water through the ring pipe. I.e., the valve 508 can create a resistance to water returning to the storage tank. This will bias water to flow out of the system, if such a path is available. For example, the outflows 56 can include a bend or other non-straight section of pipe. The valve 508 can provide back pressure which moves the water through the outflows 506. Additionally or alternatively, the valve 508 can be used to control the amount of water flowing through the ring pipe.

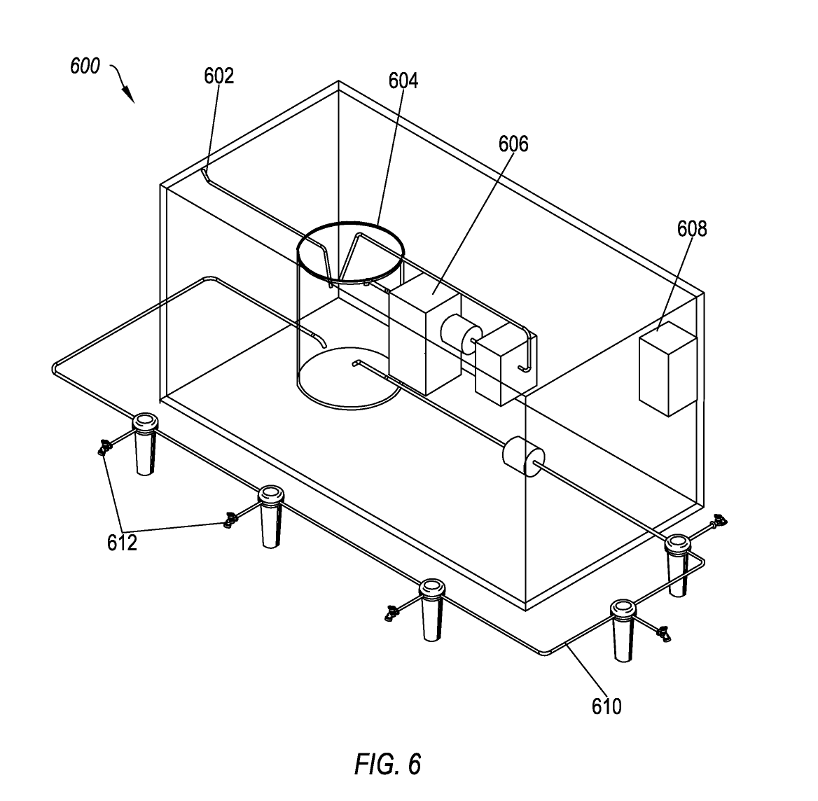

FIG. 6 illustrates an example of a system 600 for purifying water. In at least one implementation, the system 600 can allow water to be prepared for a desired use. For example, the system 600 can be used to remove microbes or other contaminants. Additionally or alternatively, the system 600 can be used to recycle waste water.

FIG. 6 shows that the system 600 can include an inlet 602. In at least one implementation, the inlet 602 can allow water to enter the system 600. The inlet 602 can allow water that is already clean to enter the system or water that needs to be purified before use. For example, the inlet 602 can be water to recycle or water from a source which contains impurities. Additionally or alternatively, the inlet 602 can allow water to enter the system 600 which is already purified or substantially purified, which will be a supplement to the purified water produced by the system 600, as described below.

FIG. 6 also shows that the system 600 can include a storage tank 604. In at least one implementation, the storage tank 604 can include water which has been purified and which is available for use. Additionally or alternatively, the storage tank 604 can include water which is in the process of being purified. One of skill in the art will appreciate that the storage tank 604 can be a combination of the two. I.e., the storage tank 604 can include water which comes through the inlet 602 and water which has been purified, as described below.

FIG. 6 further shows that the system 600 can include a sanitization circuit 606. In at least one implementation, the sanitization circuit 606 can produce a sanitizing compound. The sanitizing compound can include any chemical or combination of chemicals which can be used to purify the water. For example, the sanitization circuit 606 can include an electrolysis device which produces hypochlorite, which can be used as an oxidizing agent to remove impurities such as nitrates, nitrites, sulfates and organic compounds. One of skill in the art will appreciate that the sanitization circuit 606 can produce any sanitizing compound which is meant to remove the desired impurities from the water.

FIG. 6 also shows that water exiting the sanitation circuit is returned to the storage tank 604. In at least one implementation, the returned water can purify all of the water in the storage tank 604. For example, the water exiting the sanitization circuit 606 can have a high concentration of the sanitizing compound produced by the sanitization circuit 606. As the water exiting the sanitization circuit 606 enters the storage tank 604, the water is diluted by water already in the storage tank 604.

FIG. 6 further shows that the system 600 can include a control circuit 608. In at least one implementation, the control circuit 608 can control the operation of the system 600 or the different parts thereof. For example, the control circuit 608 can control the amount of sanitizing compound being produced, monitor the amount of the sanitizing compound in the storage tank 604 to keep it at the optimal level or within the optimal range, can control the amount of water entering the storage tank 604 or can control the amount of water exiting the storage tank 604.

FIG. 6 further shows that the system 600 can include a ring pipe 610. In at least one implementation, the ring pipe 610 can move the water from the storage tank 604, to one or more outlets 612 and then back to the storage tank 604. I.e., the ring pipe 610 can allow the water to be made accessible. Additionally or alternatively, the ring pipe 610 can ensure that any unused water is returned to the storage tank 604, preventing the waste of water.

FIG. 6 additionally shows that the system 600 can include one or more outlets 612. The outlets 612 can allow uses to access the purified water. For example, the outlets 612 can include hose bibs, where the water is accessed directly. Additionally or alternatively, the outlets 612 can include pipes or pumps which move the water to external areas where it can be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for purifying water, the system comprising:
a water input system, wherein the water input system is configured to receive water;
a sanitization circuit, wherein the sanitization circuit is configured to add a sanitization compound to the water to produced purified water; and
an output circuit, wherein the output circuit is configured to output the purified water.

2. The system of claim 1, wherein the sanitization compound includes hypochlorite.

3. The system of claim 1, wherein the water input system includes a filter, wherein the filter is configured to remove particulates from the water.

4. The system of claim 1, wherein the water input system includes a pump, wherein the pump is configured to increase the pressure of the water.

5. The system of claim 4, wherein the water input system further includes a pressure control, wherein the pressure control is configured to control the pump.

6. The system of claim 1, wherein the water input system includes a flow meter, wherein the flow meter measures the amount of water input to the system.

7. The system of claim 1, wherein the sanitization circuit includes a reactor, wherein the reactor is configured to produce the sanitization compound.

8. The system of claim 7, wherein the reactor produces the sanitization compound electrolitically.

9. The system of claim 1, wherein the sanitization circuit further includes a sanitization compound sensor, wherein the sanitization compound sensor is configured to measure the amount of sanitization compound added to the water.

10. The system of claim 1, wherein the sanitization circuit includes a pump, wherein the pump is configured to move the water through the sanitization circuit.

11. A system for purifying water, the system comprising:
a water input system, wherein the water input system is configured to receive water;
a water storage system, wherein the water storage system is configured to store the water;
a sanitization circuit, wherein the sanitization circuit is configured to add a sanitization compound to the water to produced purified water; and
an output circuit, wherein the output circuit is configured to output the purified water.

12. The system of claim 11, wherein the water storage system includes a storage tank.

13. The system of claim 12, wherein the storage system further includes a level sensor, wherein the level sensor detects the water level within the storage tank.

14. The system of claim 11, wherein the water storage system include a valve, wherein the valve is configured to prevent water from entering the storage system if the water in the storage system is above a threshold level.

15. The system of claim 11, wherein the output circuit includes a pump, wherein the pump is configured to pump the purified water from the water storage system.

16. The system of claim 11, wherein the output circuit includes an outflow, wherein the outflow allows access to the purified water.

17. The system of claim 11, wherein the output circuit includes a filter, wherein the filter is configured to remove from the purified water one of:
dissolved heavy metals;
odors; or
tastes.

18. A system for purifying water, the system comprising:
a water input system, wherein the water input system:
is configured to receive water; and
includes:
a filter, wherein the filter is configured to remove particulates from the water;
a pump, wherein the pump is configured to increase the pressure of the water;
a pressure control, wherein the pressure control is configured to control the pump; and
a flow meter, wherein the flow meter measures the amount of water input to the system;
a water storage system, wherein the water storage system:
is configured to store the water; and
includes:
a storage tank;
a level sensor, wherein the level sensor detects the water level within the storage tank; and
a valve, wherein the valve is configured to prevent water from entering the storage tank if the water level in the storage tank is above a threshold level;
a sanitization circuit, wherein the sanitization circuit:
is configured to add a sanitization compound to the water to produce purified water; and
includes:
a pump, wherein the pump is configured to move the water through the sanitization circuit;
a reactor, wherein the reactor is configured to produce the sanitization compound; and
a sanitization compound sensor, wherein the sanitization compound sensor is configured to measure the amount of sanitization compound added to the water;
an output circuit, wherein the output circuit:
is configured to output the purified water; and
includes:
a pump, wherein the pump is configured to pump the purified water from the water storage system;
a filter, wherein the filter is configured to remove from the purified water one of:
dissolved heavy metals;
odors; or
tastes; and
an outflow, wherein the outflow allows access to the purified water; and
a control circuit, wherein the control circuit is configured to control the operation of the water purification system.

19. The system of claim 18, wherein the control circuit is configured to control the amount of sanitization compound added to the water.

20. The system of claim 18, wherein the control circuit is configured to control the amount of water entering the system through the water input system.
